(19) United States
(12) Patent Application Publication
(10) Pub. No.: US 2008/0281617 A1
(43) Pub. Date: Nov. 13, 2008

(54) METHOD AND SYSTEM FOR WEB SITE MANAGEMENT

(75) Inventors: Clayton Reid Conrad, Chapel Hill, NC (US); Leonard Buck, Chapel Hill, NC (US); Kevin C. Olbrich, Cary, NC (US); Samuel Blakley Watters, Carrboro, NC (US)

Correspondence Address: Williams Mullen, P.O. Box 12109, Research Triangle Park, NC, 27709-2109, US

(73) Assignee: Near-Time, Inc., Durham, NC (US)

(21) Appl. No.: 12/105,333

(22) Filed: Apr. 18, 2008

Related U.S. Application Data
(60) Provisional application No. 60/928,709, filed on May 11, 2007.

(51) Int. Cl. G06Q 99/00

(52) U.S. Cl. 705/1

(57) ABSTRACT

Disclosed is a remotely hosted browser based software as a service (SaaS) application for allowing users to create and customize a web space over a network from a computer connected with the network. The application includes an account creation module for creating a space with a service provider of the application. There is also a space management module for customizing the space and a monetization sub-module for defining one or more fee based subscription plans for subscribers. An access control sub-module defines a level of access (reader, commenter, author) that a subscriber will have with respect to the space that is linked with the one or more fee based subscription plans.

### CROSS-REFERENCE TO RELATED APPLICATIONS

This application is related to and claims the benefit of co-pending U.S. Provisional Patent Application 60/928,709 filed on May 11, 2007 and entitled, “Near-Time Premium Business Engine and User Directed Web-Site Management”.

### BACKGROUND

The Internet has evolved from “brochure-ware” type web sites to more fully engaging and interactive web sites that assist the web site providers/owners in a wide variety of electronic projects and purposes. For example, businesses can conduct transactions through the Internet, newspapers can provide content online, political candidates can form grass roots support sites and interest groups can develop web sites that allow contributions from their members on highly specific topics pertinent to their interest group. The Internet can facilitate practically any purpose where communication is required.

While the term “Web 2.0” is sometimes overused, it is useful shorthand for the type of web application currently spreading like wildfire on the Internet. Web 2.0 applications radically lower the barriers to capture user-created content and enable high levels of collaboration and communication. Weblogs, also known as blogs, and wikis, which are editable web pages, are the most common examples of these two-way, easy-to-use web applications. Tens of millions of users on the Web use these types of tools every day to reach out to and participate in conversation with their friends, family and co-workers.

In Web 2.0 environments, information and organizational knowledge created by users and captured by blogs and wikis is discoverable via search. It is also less interruptive and can be easily leveraged by the organization. Contrast this with traditional collaboration methods, which tend to disturb workflow and leave vital business information trapped inside user's e-mail accounts, personal file systems, and voice conversations. Additionally, Web 2.0 technologies allow conversations to occur on a larger scale and reach bigger audiences than traditional tools, providing yet another opportunity to get significantly increased benefits.

### SUMMARY

Disclosed is a remotely hosted browser based software as a service (SaaS) application for allowing users to create and customize a web space over a network such as the Internet from a computer connected with the network. The application includes an account creation module for creating a space with a service provider of the application. There is also a space management module for customizing the space and a monetization sub-module for defining one or more fee based subscription plans for subscribers. An access control sub-module defines a level of access (reader, commenter, author) that a subscriber will have with respect to the space that is linked with the one or more fee based subscription plans.

Creating a space via the account creation module entails, in no particular order, collecting data pertaining to an account owner, establishing a fee structure between the account owner and the service provider of the application for usage of the application, And establishing a log-in identifier for the account owner to access the space just created.

Defining one or more fee based subscription plans entails creating one or more offer codes wherein an offer code includes terms pertaining to a length of a subscription, a fee for the length of the subscription, and a level of access to the space to be afforded by the subscription. Offer codes can be distributed via email and can include an expiration date such that the terms included with the offer code are invalid upon reaching the expiration date. The length of a subscription can include a renewable monthly term, a renewable yearly term, and a permanent term.

Reader access permits a subscriber to view content in the space. Commenter access permits a subscriber to view content in the space, provide comments on the content in the space, and add posts to forum topics. Author access permits a subscriber to view content in the space, provide comments on the content in the space, and create new content in the space.

The software application can further include an analytics sub-module for tracking usage statistics of the space. Usage statistics can include at least one of page hit counts, offer code table, subscription accounting summary, subscriber information, list of readers, list of commenters, list of authors, list of accessed content, monies collected, memory used, and recent subscriber activity.

The space management module further includes a pages sub-module for adding content to the space based on wiki formatting. Content includes at least one of blog entries, task entries, forum entries, image files, audio files, video files, data files, and calendar entries.

### BRIEF DESCRIPTION OF THE DRAWINGS

FIG. 1 is a network diagram describing an environment in which the invention can be practiced.

FIG. 2 is a diagram of software modules that comprise the software application.

FIG. 3 illustrates high level processes of the software application.

FIG. 4 illustrates processes for establishing an account with a service provider.

FIG. 5 illustrates processes involved in creating a space using the software application.

FIG. 6 illustrates processes involved in managing and using a space.

FIG. 7 is a sample screen shot that a subscriber can use to subscribe to a space.

### DETAILED DESCRIPTION OF THE EMBODIMENTS

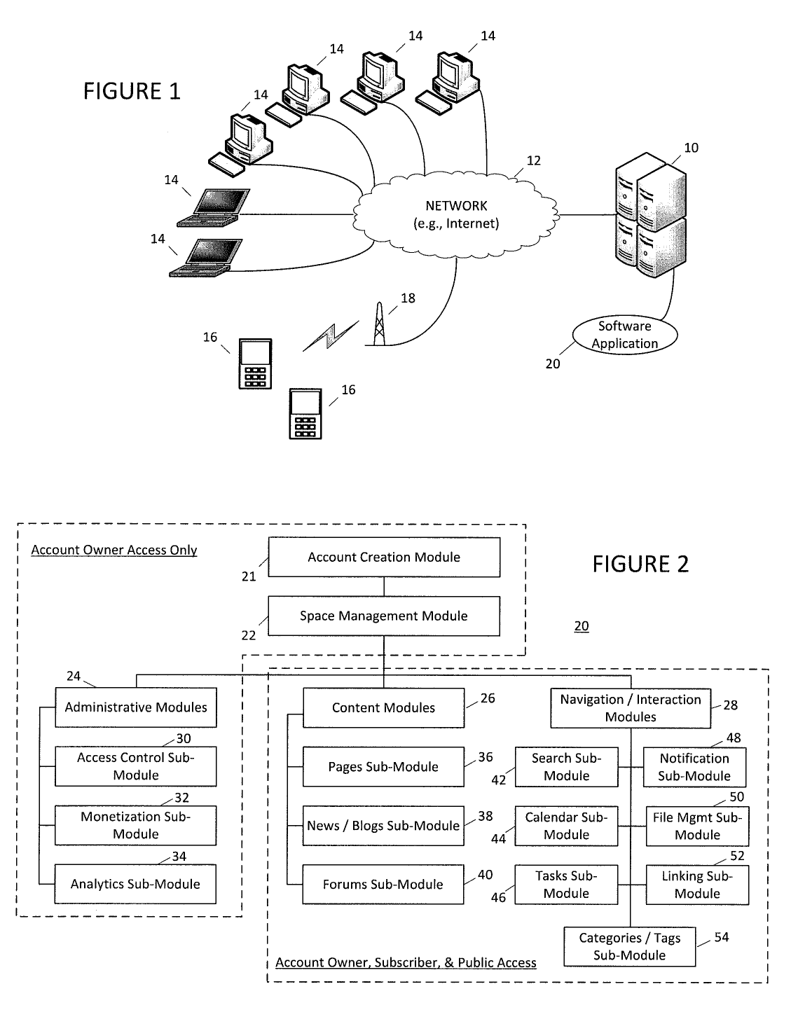

FIG. 1 is a network diagram describing an environment in which the invention can be practiced. As a software as a service (SaaS) application 20, the invention resides in large part on a server 10 that is in communication with a network 12 such as, for instance, the Internet. The network 12, in turn, is communicable with a wide variety of other computing devices 14, 16 that can, upon proper provisioning, be communicable with the server 10 that contains the hosted software application 20. The other computing devices 14, 16 can include, but are not limited to, desktop/laptop computers 14 communicable with the network 12 and handheld/mobile phone computer platforms 16 that would communicate via a mobile (or WiFi) network 18 to the network 12.

In this environment, a computing device such as a desktop 14 can navigate via a web browsing tool to a web-site (server 10) that hosts the software application 20 and create an account with a service provider of the software application 20 so that one or more spaces can be created. As will be described more fully below, an account owner can then populate a space (or spaces) using on-line tools and modules provided by the software application 20 and invite subscribers to join and participate in varying degrees in the space. Subscribers can similarly access a space via the computer environment illustrated in FIG. 1. Spaces can be assigned unique universal resource locator (URL) tags to facilitate web navigation and search engine identification. In other words, a space is akin to a web-site. Moreover, a space can be comprised of one or more pages containing content and/or other data.

FIG. 2 is a diagram of software modules that comprise the software application 20 of the invention. The software application 20 can be organized functionally as illustrated in FIG. 2. The software application 20 itself is not necessarily constrained to that presented in FIG. 2. Rather, FIG. 2 is merely presented as a way of describing components that comprise the software application 20.

There are four entities representative of people that are described throughout this disclosure. They include a service provider, an account owner, subscriber(s), and the general public. While each entity can be associated with a person or organization, these entities are also associated with computers and software as described throughout this disclosure.

The service provider generally owns, operates, and manages the software application 20 as a hosted application resident on one or more server(s) 10 that are communicable with a network 12 such as the Internet. A service provider has direct dealings with account owners. The goal of the service provider is to establish relationships with account owners who, in turn, create spaces hosted by the service provider.

An account owner is an individual or organization that interfaces with the service provider for the purpose of gaining access to and using the service provider's hosted software application 20 and its associated tools and modules to create and manage one or more spaces. An account owner then becomes the manager of their own space(s) that they are allocated by the service provider. As such, an account owner has the ability to create, manage, and operate one or more spaces. The account owner is then free to solicit subscribers to the spaces. It is up to the account owner to decide the terms of a subscription, specifically the relationship between the cost and the level of access a subscriber will have with respect to a space.

Subscriber(s) are individuals or groups that presumably find value in an account owner's space and desire to gain access to such space. Thus, subscribers can subscribe to individual spaces that are managed by account owners. One of the novel aspects of the invention is an account owner's ability to structure individual relationships with subscribers that grant varying degrees of access to the spaces in exchange for individually structured fee agreements. Depending on the nature of the space, a subscriber may wish to have enhanced access to the space. For instance, a subscriber may be willing to pay for the right to view privileged content not available to the general public. Or, a subscriber may be willing to pay even more for the ability to post comments on content in the space. A subscriber may even be willing to pay an additional fee for the privilege of adding content to the space. It should be noted that subscribers do not have direct interaction or a direct relationship with a service provider. Subscribers interact with account owners.

Lastly, there is the general public. In so far as an account owner makes a space (or a portion thereof) visible to the general public, the general public will have the ability to view non-privileged content made available by the account owner.

In general, there is an account creation module 21 that serves as the starting point for a prospective account owner wanting to use the software application 20. The account creation module 21 assists in establishing a relationship between a prospective account owner and the service provider of the software application 20. Once a primary relationship is established between an account owner and the service provider, the account owner is granted access to a space management module 22. The space management module 22 is a catch all shell that includes various functional modules and sub-modules that comprise the rest of the software application 20. Within the space management module 22 there are three categories of modules.

One set of modules can be termed administrative modules 24. Administrative modules 24 are for managing the administrative aspects of the account owner's account with the service provider as well as the account owner's relationships with subscribers. Another set of modules can be termed content modules 26. Content modules 26 include the tools and sub-modules for adding, deleting, and editing content within a space. Yet another set of modules can be termed navigation/interaction modules 28. The navigation/interaction modules 28 include tools and sub-modules that enrich and enhance both the account owner's and subscriber's experience with respect to the space created and managed via the software application 20.

Generally speaking, the account creation module 21, the space management module 22, and the administrative modules 24 (and administrative sub-modules 30-34) are restricted to account owner access only. These modules are directed at the management of the space(s) that an account owner has created. The content modules 26 and content sub-modules 36-40 as well as the navigation/interaction modules 28 and navigation/interaction sub-modules 42-54 may be accessible to subscribers as well as the account owner. Subscriber access is directly tied to a subscription plan to which the subscriber has agreed with the account owner. Examples of varying subscriber access levels and the roles and permissions associated therewith are more fully described below.

Referring again to the administrative modules 24, there are sub-modules for access control 30, monetization 32, and analytics 34.

The access control sub-module 30 provides the account owner with the ability to invite, control, restrict, expand, and change subscriber access and subscriber privileges with respect to the space thereby bringing people (subscribers) and content together without the friction found in formal content management systems. People are invited to become subscribers by the account owner. Each subscriber can then extend their own invitations to other potential subscribers. All that is needed to send an invitation is an email address or a user name that is associated with the software application 20. Invitations can be delivered through email, and joining a space upon receipt of an invitation is quick and easy.

Access control sub-module 30 can further be used to denote whether the content in a space can be viewed by the general public. The account owner can specify what portion (pages) of a space should be made public through various access settings. Public access can be further restricted to content categorized as public. Additionally, access control sub-module 30 can be used by the account owner to assign various roles and permissions to subscribers based on their subscription plan.

The access control sub-module 30 can also include the ability to export an entire space into, for instance, a zip archive. The space may also be copied or cloned. There is also an option that allows the account owner to close the space on demand wherein no one (including subscribers) will have further access to the space until it is re-opened.

The monetization sub-module 32 facilitates the packaging and selling of content. The monetization sub-module 32 provides the account owner the ability to set different fee structures depending upon the level of access and other benefits that a subscriber desires. In general, a subscriber can have reader, commenter, or author privileges with respect to a space.

The analytics sub-module 34 allows the account owner to request and retrieve statistical, accounting, and analytical information surrounding the use of the account owner's space. Through this information, the account owner can be empowered to make better decisions regarding the type of content, the type of subscribers, and the type of features that are most desirable in the space.

Referring again to the content modules 26, there are sub-modules for pages 36, news/blogs 38, and forums 40. The software application 20 provides a set of tools and a web based interface to easily and efficiently add, remove, and edit content to a web space. Moreover, individual subscribers may also have the ability to manipulate content in the space depending on the roles and permissions they have been granted in their subscription agreement with the account owner.

The pages sub-module 36 enables the account owner and/or subscribers to create pages that become instantly editable by each authorized subscriber in the space. As a wiki, participation in a space using the present invention is democratic. While the account owner of a space has special access to space settings (like themes and public access), each authorized subscriber may have an individual ability to edit and comment on the same content depending on the level of access granted by their subscription plan with the account owner. The software application 20 allows the account owner to encourage participation in the space. Version and change history is automatically tracked and the account owner can always go back in time if needed. Page authoring can be supported by simple wiki formatting. Each page can include links, images, widgets and file attachments, such as PDFs and media files. Feedback can be added to the page directly or appended as a comment.

The news/blogs sub module 38 allows the account owner and/or subscribers to provide a team weblog within a portion of the space, for example, which can be ideal for making announcements and sharing ideas. Subscribers may be permitted to post a new article or comment on existing posts. Blog articles can contain links, images, widgets, or attached application files.

The forums sub-module 40 enables the account owner and/or authorized subscriber to create Forums for group discussion. Authorized subscribers may set up one or more forums, which can be categorized, then create topics, which can be tagged, for each forum. Account owner may permit subscribers, and when permitted, the public to post to topics.

Referring again to the navigation/interaction modules 28, there are sub-modules for searching 42, a calendar 44, tasks 46, notifications 48, file management 50, linking 52, and categories/tags 54.

The search sub-module 42 enables quick key word searches as well as advanced searches involving a wide range of metadata (e.g., category, tag, contributor . . . ). Searches can be saved to create dynamic views that filter and re-mix the space's content based on a custom rule-set. Saved searches can appear as links within the Search interface and can be dynamically updated as new matching content is added.

The calendar sub-module 44 enables the account owner and/or subscribers to schedule, plan, and review upcoming events. Each event can include links to related articles, pages, files, or external web resources.

The tasks sub-module 46 allows the account owner to manage project timelines. The account owner and/or subscribers can create milestones, set due dates, task status, and mark items as completed. Space subscribers can comment on the task assigned to them, as well as attach related files. The software application 20 can keep a history of all the changes to a task timeline.

The notification sub-module 48 allows for interoperability with e-mail, really simple syndication (RSS), and weblog application programming interfaces (APIs). For example, news, pages, and events tabs in a space can each have a corresponding email address that the account owner and/or subscribers can use to post to the space directly through email. A subscriber can also subscribe to receive email notifications of changes made within News, Page or Events, for example, or of all changes made within the entire space. Similarly, the software application 20 can offer a variety of RSS feeds, enabling the account owner to monitor new activity within a news reader. Feeds are available for all content or at the tab-level (New, Pages, Events). In one embodiment, attached files are captured in the RSS feed as enclosures—a quick and easy way to automatically capture local versions of the files added to a space. Additionally, the software application 20 supports the MetaWeblog API, enabling the account owner and/or subscribers to post news articles directly from external weblog editors such as MarsEdit™.

In addition to email and RSS notifications, the notification sub-module 48 includes an internal notification system that enables the account owner to quickly discover the latest contributions by subscribers. A star icon can be made to appear on the spaces listing whenever new content has been added by a subscriber. Mousing over the star can highlight the specific areas where updates have been made. The star can also appear next to any new articles, pages, or comments. In one embodiment, there is provided a recent activities option showing a more granular view of changes within a space. This listing can point to the latest content updates and also includes category changes and new subscribers.

The file management sub-module 50 provides centralized access to the files attached to articles and pages throughout the space, or uploaded directly to the files tab. The account owner and/or authorized subscribers can download a file by clicking on its name. To perform other file management options such as replacing a file, editing a file or checking into or out of a file, for example, the user can click on a file name to view the information gathered on a particular file, including history and comments. A check-out option can be used to update the file while letting others know that the user will be working on it. A check-in option can be used to make the updated file available to the other members.

The linking sub-module 52 permits linking resources together. News articles, wiki pages, and calendar events are companion components to effective collaboration. For example, news articles are great for information sharing, while the wiki supports content synthesis. Ideas are often initially expressed in a news post, with a link to a wiki page or forum topic for further discussion and synthesis. Similarly calendar events typically link to associated content in the form of wiki pages, such as directions, itineraries, and meeting notes. Wiki syntax can be employed to link the user's resources together. Linking is also facilitated through the editing toolbar. When linking to an article, page, or image, a toolbar prompts the user to enter a name for the link and a title of the resource. As the title is entered, the software application will offer matches for selection in a drop down menu, for instance.

The categories/tags sub-module 54 supports both traditional category based organization as well as liberal tagging support. Categories provide a group-wide classification scheme, while tags enable the user to associate keywords or other useful metadata with a particular piece of content. Categories and tags can be used in tab-level and global content filtering (via search), enabling the user to quickly find the content of interest.

Tags are freeform bits of contextual information that can be applied to a piece of information stored on a space. Tags can be any string of characters such as “Draft”, “For Review”, “Final”, etc. Unlike pre-defined categories, tags allow account owners or authorized subscribers to apply custom organization information at the point of creation or use. In one embodiment of the present invention, tags can be easily applied to new blog posts, wiki pages, event information, files and tasks—giving users an easy way to organize content or generate lists of related content. The present invention further accommodates advanced syndication capabilities (e.g., RSS and Atom) which give account owners the ability to push content to their subscribers.

The preceding has described the modules and sub-modules of the software application 20 in the abstract. The following is a description of how a user can establish an account with a service provider and use the software application 20 generally. Thereafter, several use case scenarios are presented that further illustrate the versatility and functionality of the software application 20.

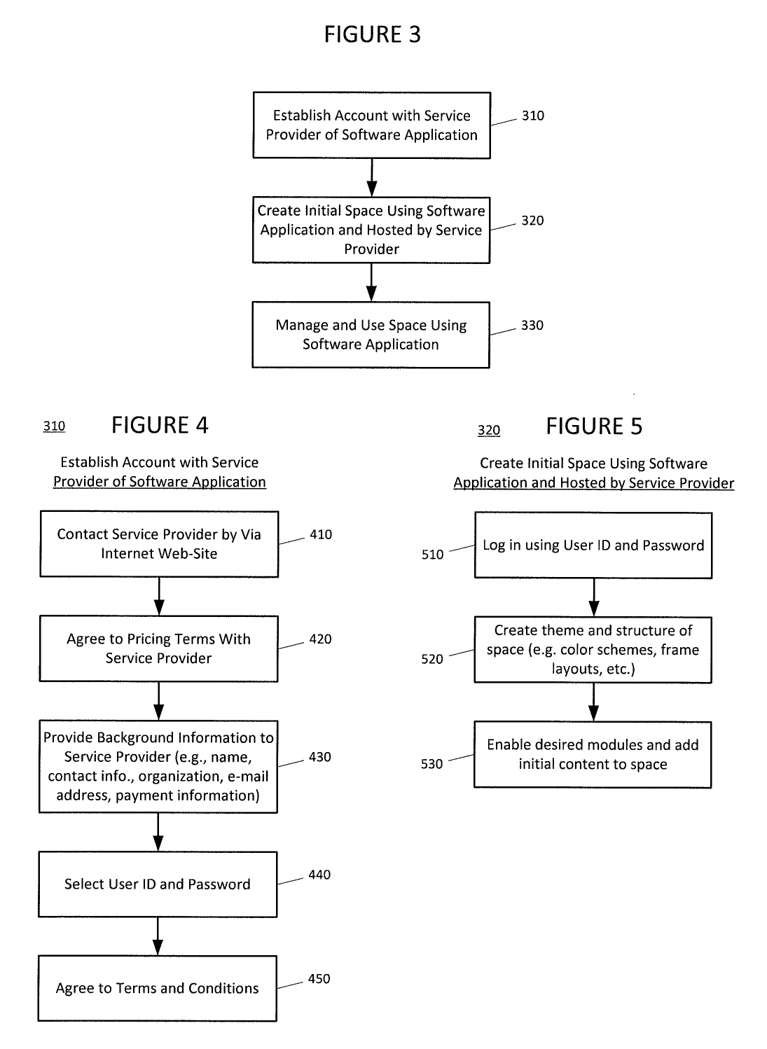

FIG. 3 is a flowchart for high level processes. One high level process comprises establishing an account with the service provider of the software application 310. A second high level process comprises creating an initial space hosted by the service provider using the software application 320. A third high level process comprises managing and using the space using the software application 330.

The process for establishing an account with a service provider of the software application 310 is further described with reference to FIG. 4. The first step for a prospective account owner is to contact the service provider 410. This is typically done by navigating on the Internet to the service provider's web-site. The prospective account owner can then find the appropriate hyperlinks necessary to begin the process of setting up an account with the service provider. The prospective account owner can agree to pricing terms 420 with the service provider with respect to how fees collected from subscribers will be split between the account owner and the service provider. A next step is to provide relevant background information 430 to the service provider including, but not limited to, name, contact information, and payment information. The account owner is then prompted to select a user ID and password 440 to gain access to his space(s) and to the software application in general. The account owner becomes fully active once he agrees to the terms and conditions regarding usage of the software application and the service provider web-site 450.

Once the account has been created and activated, the account owner may begin to create an initial space 320. FIG. 5 illustrates processes involved in creating an initial space. The account owner first logs in 510 by providing his unique account verification data to the service provider. This typically, but not necessarily, takes the form of an established user ID and password combination. Other account verification techniques, however, may be used with the present invention.

Once the log-in is verified by the service provider, the account owner is given access to his space(s) and to the software application. One of the first tasks for the account owner is to create or select a theme for the space 520. This may involve choosing color schemes, page/frame layouts, tab settings, and more. The account owner will also enable specific modules (e.g., calendar, tasks, etc.) that will be usable within the space by the account owner and authorized subscribers 530. Once the overall structure has been implemented, the account owner may begin adding actual content in the appropriate areas just created. Content can include, inter alia, news articles, initial blog postings, wiki pages, forums, a calendar of events, task assignments, audio and/or video files, photos, or other files.

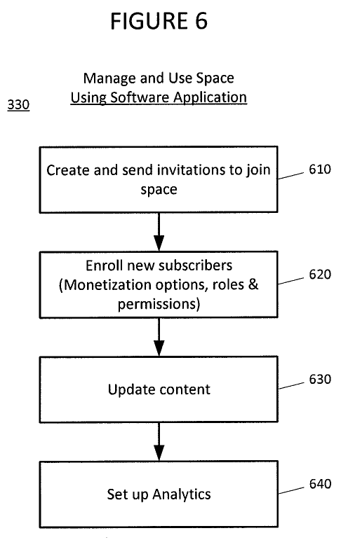

After the account owner has initially created a space, it is ready to be managed by the account owner and used by subscribers 330. FIG. 6 illustrates some of the high level processes involved in managing and using a space. Usage of a space is a dynamic ongoing process in which the space evolves based on new content provided by the account owner and authorized subscribers. One of the first steps that an account owner can take is to solicit potential subscribers 610. Subscriber solicitation can be done in several ways.

One method involves the account owner sending out invitations to subscribe to the space. Invitations can be sent out via email directly to potential subscribers. The emails may contain information about the space including features available to subscribers. An invitation can also include rate information and special offer codes as well as a hyperlink to a page within the space that further details the subscribing process.

Invitations may also be extended in a more general fashion through print media that contains information similar to or the same as an email invitation. A potential subscriber can navigate to the space using a URL given in the print media. Or, the space may be accessible directly via the Internet to a home page (i.e., a top-level domain) within the space. The space may also be “found” via results of a search engine. The home page can contain more detailed information about the space and how to join as a subscriber. A prospective subscriber can follow the instructions on the home page which could be a hyperlink to a subscriber enrollment page to begin the process of becoming a subscriber. Once a subscriber has navigated to the subscription enrollment portion of a space, he may peruse the options in order to make a decision whether to subscribe 620.

To set up paid access to the interactive space, the account owner can establish a default rate plan. The account owner may also use specific offer codes for potential subscribing members. The account owner can choose to set up a single default rate plan or one or more additional rate plans that can include dollar amount, frequency of billing, offer code expiration. The rate plans will also be linked to a subscriber's roles and permissions upon signup. The roles and permissions define the level of access and contribution the subscriber will have with respect to the space upon subscribing.

The account owner can set up a base fee structure for the space, by providing a default offer code that is linked with information concerning an expiration date for the default offer code (once date is reached, this code is no longer available for new subscribers), subscriber roles and permissions on signup (reader, commenter, author), the rate to be charged, with options to set dollar amounts for each of the following payment intervals: monthly; yearly; or one time.

An account owner may want to offer additional offer codes other than just the “default” offer code. To do this, the account owner can click on an “add offer code” icon to create additional subscribing offers. An account owner can give each additional rate plan its own offer code name or title. Setting up additional offer codes enables an account owner to control access to the space content by setting various rates, roles, and permissions for subscribers.

For example, an account owner may set a rate and role for attendees of a conference so they may access conference materials. This offer code may be advertised at the conference. The account owner may also want to offer conference presenters a special rate, providing them with access to the space at no cost. The account owner would create a second offer, leaving the rate field blank. Individuals who are going to attend the conference join the space with the default offer code and the presenters could enter the special offer code.

The offer code title can be a logical identifier that prospective subscribers enter into a sign up page in order to subscribe to a particular rate plan for a space. The account owner may want to create multiple offer codes, advertising some of the codes to the public and sending other codes privately to other potential subscribers. If only the default rate plan were to be used, subscribers would not have to enter an offer code when to join the space as all plans would be equal.

An account owner further has the option to set an expiration date for offer codes. The offer code expiration date controls whether an offer code can be used when subscribing to a space. The rate plans themselves do not necessarily expire, but if the expiration date for an offer code is reached, that offer code can no longer be used to subscribe to the space.

An example of when an account owner may want to set an expiration date would be if they would like to change the amount that is being charged for a particular offer code. The account owner would set an expiration date for that offer code. Upon reaching the expiration date, new subscribers would no longer be able to enter the expired offer code when they subscribe to the space. To charge a different amount, the account owner could set up a new offer code and specify a new dollar amount, making this new offer code available for subscribers. An account owner may also want to set a code to allow potential subscribers discounted access to the space, but may want to have the offer code available for a short window of time, thereby limiting the duration that people can subscribe at that rate. Also, multiple offer codes with the same name can be created, but only the nearest unexpired expiration date will be accepted. Once the first expiration date is reached the next rate will be automatically invoked under that offer code name.

The rate plans described above are further tied to levels of access that a subscriber will be afforded while using the space. Once an individual becomes a subscriber they are eligible to participate in the space to the extent their subscription allows. There are generally three levels of access that a subscriber can have to a space. Reader access allows the subscriber to view the pages of a space including those restricted from the general public. Commenter access is reader access plus the ability to provide feedback on the content in the space. Author access incorporates commenter and reader access and further allows the subscriber to add content to the space.

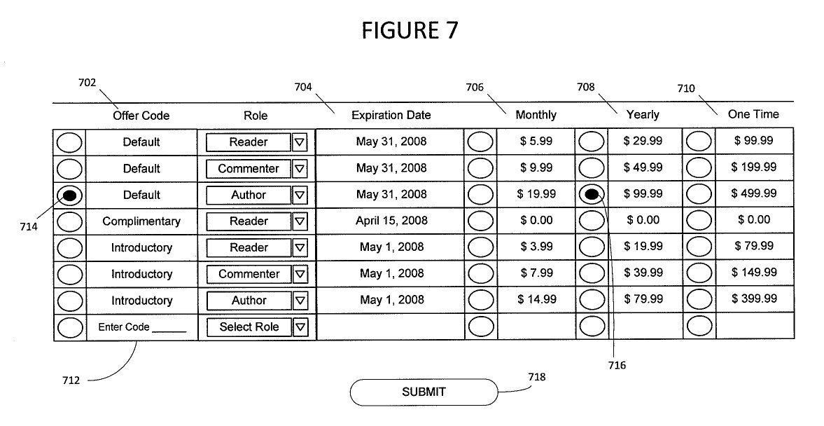

FIG. 7 is an example screen shot that a subscriber can use to subscribe to a space. The account owner can set up any number of subscription plans having different costs associated. In this example, there are headings for the offer code name 702, an expiration date 704, a monthly subscription fee 706, a yearly subscription fee 708, and a one time fee 710. Under the offer code heading 702, this example lists a default plan, a complimentary plan, an introductory plan, and blank plan that will be associated with a special offer code that the subscriber enters 712.

Under the default plan and the introductory plan, the account owner has chosen to offer rate structures for reader, commenter, and author access. Under the complimentary plan, the account owner is offering reader access for free. This can be further refined in the terms and conditions to stipulate that complimentary reader access is good for 90 days at which time the subscriber would have to switch into a different subscription plan to maintain access to the space.

Both the default and introductory plans offer the same levels of access at different prices. The account owner, in this instance, has chosen to give a discount to early subscribers under the introductory plan. The introductory plan expires on May 1, 2008. After that period, new subscribers will not be able to subscribe under that plan since it is past the expiration date. The blank plan depends on the subscriber entering a special offer code 712 that was made available in some manner. Once the subscriber enters the special offer code, the software application will match it against a rate structure created by the account owner and display the results. The subscriber then has the option of selecting this plan.

In this example, the subscriber has selected the default-author plan 714 to be paid on a yearly basis 716 as evidenced by the checked button boxes. Once the selection is made, the subscriber can click the “submit” button 718 and the software application will proceed to inform the subscriber of his rights, privileges, roles, and permissions as well as take any requisite payment information such as credit card, banking, or PayPal™ information.

FIG. 7 is exemplary in nature and those of ordinary skill in the art could readily devise an alternative screen for presenting rate information and collecting subscriber input. The purpose of the screen shot is to show how it is possible to link the monetization aspect of the invention with the level of access (collaboration) aspect of the invention.

Referring back to FIG. 6, once the space pages have been initially set up, the account owner is free to update the content 620 and layout at any time. In addition, subscribers having commenter and/or author privileges are also free to participate in the evolution of the space pages by commenting on or adding content. Updating content is performed using the modules (previously described) that the account owner has made available when initially creating the space.

Another high level process available to the account owner is a set of analytic processes 640. Analytics include data pertaining to space usage by the account owner and the subscribers. The account owner can keep track of a variety of statistical measures that pertain to space usage including, but not limited to, subscriber details, page hit counts, offer code tables, most frequent readers, most frequent commenters, most accessed content, least accessed content, etc.

In one embodiment, the account owner can have access to two different accounting summaries generated by the analytics sub-module 34. On a first accounting summary page, each rate plan can list, for example, offer code name, expiration date, monthly rate, number of subscribers for monthly rate, payments made at the monthly rate, yearly rate, number of subscribers for yearly rate, payments made at the yearly rate, one time rate, number of subscribers for one time rate, payments made at the one time rate, total number of subscribers, total payments by last 30 days, 90 days and to date. In addition there can also be a summary for all rate plans listing, for example, total subscribers and total payments by last 30 days, 90 days and to date.

Details about the space can also be made available on the analytics page such as, for instance, the number of news articles, pages, events and files and how much file space they are consuming. There can be a summary of the website audience, listing number of subscribers, who can invite others into the space and whether content is available to the public in addition to the subscribers of the website or if it is only available to subscribers of the space. In addition, recent activity by members of the space is also listed.

Account owners can also see an accounting summary on an account page of all the spaces they own. On that page, each space lists, for example, the space name, a space name description, the number of members, the number of subscribers, and payments in the last 30 and 90 days.

Other analytical statistics may also be created and displayed using the software application. Those detailed above are not considered limiting to the present invention. Rather, they are illustrative and exemplary.

The following are use case scenarios that highlight various capabilities unique to the software application 20. While no single use case scenario fully illustrates all of the capabilities of the software application 20, the collection of use case scenarios provide a better understanding of how a user can utilize the software application 20 to achieve specific goals in a most efficient manner.

The software application 20 gives individuals and small businesses a unique opportunity to quickly and easily create and maintain their own commercial marketplaces, in an affordable manner. With a hosted platform and built in e-commerce services, there is no need for individuals and businesses to be burdened with the extra expense of a technical support staff or web development team that is often required to set up a website, let alone a commercial marketplace. Once an account owner signs up with a service provider, they are able to create any number of spaces, each with a focused community. Spaces can be customized to fit many different commerce opportunities, allowing the account owner to setup subscription rate plans, public and private collaboration, and subscriber roles to fit their needs at any given time. A space may be originally created to fulfill one need, but it can easily be expanded at any time by the account owner, requiring little effort.

Normally, building an e-commerce space would involve hiring a team of web developers and administrators, with development possibly taking months to complete. The hosted platform associated with the software application of the present invention makes it easy for space owners to create any number of collaborative commercial marketplace spaces within seconds. The software application provides easy to use tools and modules that enable instant creation of news articles and web pages, uploading and sharing files, scheduling events, searching content, and creating tasks. Each space can easily be customized to allow both public and private collaboration access and publishing.

An account owner can set up multiple rate plans to control subscriber access based on roles. For instance, an author can create new content, a commenter can leave comments, and a reader can simply read the content. In addition, an account owner can set up billing rates, based on intervals of monthly recurring, yearly recurring or one time payments. Rates and intervals of payments can be used in a variety of combinations, providing the account owner with multiple options for monetizing content.

Below are some examples of how commercial marketplaces can instantly be set up using the software application for a new part-time small business opportunity, a campaign collecting donations and allowing collaboration based on roles, a monthly newsletter with both public and subscription-based access to content, and an annual conference.

### Small Business Opportunity

Paul has a full-time job as an accountant, but he is also very skilled at graphics and video design. His friends, family and co-workers often ask for advice and help. As the requests continue to increase, Paul realizes that he could earn extra money giving graphical and video advice, as well as doing part-time consulting. In order to streamline his new business with the least amount of overhead, Paul registers with a service provider of the software application. He will not have to maintain any hardware or software himself, further cutting his expenses. He creates a space with a custom domain name. The space publicly advertises his availability as a graphics and video consultant. The space showcases an advice column and step-by-step training videos, all available at a small cost through a subscription. Paul sets the role for the default subscription to “commenter”, which will allow subscribers to read and comment on the space content. Paul may eventually ask other graphics and video experts to contribute content to the space. To allow the experts to author their own content, Paul can set up an additional special offer code, where the rate is set to zero and the subscriber role is set to “Author”. When he's ready, he would let the experts know the appropriate offer code to gain access to the space under this special rate.

### Campaign Donations

Sally is running for town council. She would like to keep her loyal supporters informed, as the campaign moves forward, on the issues she feels are important. She would also like to be able to collect donations from fellow citizens who would like to support her campaign. Sally has been using the software application to plan a family reunion in one space, and realizes she can easily set up a new space for her campaign to collect donations. She sets up categories of topics that she feels are important to the campaign. She would like to allow donors to have the ability to collaborate on issues they feel are important in this campaign. She would also like donors to have the ability to comment or just read the content that's added to the space. She sets up multiple subscription rate plans, with a different donation amount for each one, and a specific role. For a small donation, you can have access to read content. For a slightly larger donation, you can read and comment on content. And for the largest donation, you have the ability to collaborate with others on the hot topics of the campaign.

### Monthly Free and Subscription-Based Newsletter

John is part of a small group of local veterinary professionals who have been putting out a basic free paper newsletter twice a year. They decide to convert to an online monthly newsletter that provides some content free to the public (including their existing archive from the paper newsletter), and has a subscription-based veterinary advice blog. The small group can't afford to maintain their own servers, nor can they afford to pay for any technical support staff. A friend of John's suggests that they use the hosted platform of the software application to publish their free newsletter and subscription-based advice blog. The group will not have to maintain any servers or software, nor will they need to find funding to pay for their own technical support person. John sets up an account, then proceeds to create the space. He invites the local veterinary professionals to be subscribers of the space, setting them each up with the author role under a special (no fee) offer code so they can add their existing content into web pages and collaborate on new content for the website. The group decides to set the default offer code to give other subscribers the role of “Commenter”. The subscribers will then have full access to read the advice blog and will also be able to ask questions or just chat by leaving comments. Subscribers will also have access to view upcoming events on a calendar. The default offer rate will be set at a small monthly recurring payment, or a slightly discounted yearly recurring payment. To get the subscriptions started, they will also offer an additional subscription rate that will only be available for 30 days and will be less money than the basic rate. They plan to announce this special rate in an email to their subscribers, letting them know that they will have 30 days to join at this rate, using the special offer code. Once the special offer code expires, all other subscribers will be offered the basic rate.

### Annual Conference

A local computing group pulls together their staff to prepare for an annual conference. Using the software application, they register with a service provider and create a space. The space includes publicly accessible pages and news article regarding the upcoming conference. They set the default rate plan to a one-time fee. An email is sent out to the conference attendees from the previous year announcing the upcoming conference and instructions for registering for the conference. The one time fee will include attending the conference, access to pre-conference content (such as interviews with presenters), as well as the conference proceedings. Potential conference attendees go to the conference join page within the space, enter the conference offer code and fill in the billing information.

Once completed, the conference attendees instantly have access to the conference space content. As the number of conference attendees grows, the group can access the list of people who have signed up for the conference, the rate they paid, as well as an overall summary. A major software company offers to provide a discount to potential conference attendees if people sign up by a particular date. The group simply sets up a new conference rate offer, which is a $40 savings over the original rate, but this offer code will expire by the date set by the major software company. Potential conference attendees will have to act fast to get the special deal—once the expiration date has been reached the rate is no longer available.

Conference materials such as, for instance, papers, handouts, brochures, power point presentations, audio or video files (e.g., recordings of live presentations), question and answer sessions, and links to other related topics can be presented in the space so that conference attendees (space subscribers) can access and download desired materials per their conference subscription agreement.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any prompts associated with the present invention may be presented and responded to via a graphical user interface (GUI) presented on the display of the mobile communications device or the like. Prompts may also be audible, vibrating, etc.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A remotely hosted browser based software as a service (SaaS) application for allowing account owners to create and customize a web space over a network from a computer connected with the network, the application comprising:
an account creation module for creating a space with a service provider of the application;
a space management module for customizing the space;
a monetization sub-module for defining one or more fee based subscription plans for subscribers; and
an access control sub-module for defining a level of access that a subscriber will have with respect to the space wherein the level of access depends on the privileges afforded by the one or more fee based subscription plans.

2. The remotely hosted browser based software as a service (SaaS) application of claim 1 wherein the network is the Internet.

3. The remotely hosted browser based software as a service (SaaS) application of claim 1 wherein creating a space via the account creation module comprises:
collecting data pertaining to an account owner;
establishing a fee structure between the account owner and the service provider of the application for usage of the application; and,
establishing an log-in identifier for the account owner to access the space,

4. The remotely hosted browser based software as a service (SaaS) application of claim 1 wherein level of access includes reader access in which a subscriber is permitted to view content in the space.

5. The remotely hosted browser based software as a service (SaaS) application of claim 1 wherein the level of access includes commenter access in which a subscriber can view the content in the space and provide comments on the content in the space.

6. The remotely hosted browser based software as a service (SaaS) application of claim 1 wherein the level of access includes author access in which a subscriber can view the content in the space, provide comments on the content in the space, and create new content in the space.

7. The remotely hosted browser based software as a service (SaaS) application of claim 1 wherein defining one or more fee based subscription plans comprises:
creating one or more offer codes wherein an offer code includes terms pertaining to a length of a subscription, a fee for the length of the subscription, and a level of access to the space to be afforded by the subscription.

8. The remotely hosted browser based software as a service (SaaS) application of claim 7 wherein an offer code can be distributed via email.

9. The remotely hosted browser based software as a service (SaaS) application of claim 7 wherein an offer code includes an expiration date such that the terms included with the offer code are invalid upon reaching the expiration date.

10. The remotely hosted browser based software as a service (SaaS) application of claim 7 wherein the level of access to the space to be afforded by the subscription includes: reader access in which a subscriber is permitted to view content in the space; commenter access in which a subscriber can view the content in the space and provide comments on the content in the space; and author access in which a subscriber can view the content in the space, provide comments on the content in the space, and create new content in the space.

11. The remotely hosted browser based software as a service (SaaS) application of claim 7 wherein the length of a subscription includes: a renewable monthly term; a renewable yearly term; and a permanent term.

12. The remotely hosted browser based software as a service (SaaS) application of claim 1 further comprising an analytics sub-module for tracking usage statistics of the space.

13. The remotely hosted browser based software as a service (SaaS) application of claim 12 wherein usage statistics include at least one of page hit counts, offer code table, subscription accounting summary, subscriber information, list of readers, list of commenters, list of authors, list of accessed content, monies collected, memory used, and recent subscriber activity.

14. The remotely hosted browser based software as a service (SaaS) application of claim 1 wherein the space management module further comprises a pages sub-module for adding content to the space.

15. The remotely hosted browser based software as a service (SaaS) application of claim 14 wherein the pages sub-module for adding content to the space is based on wiki formatting.

16. The remotely hosted browser based software as a service (SaaS) application of claim 15 wherein content includes at least one of blog entries, task entries, forum entries, image files, audio files, video files, data files, and calendar entries.

17. A computer readable medium storing a computer program product for allowing account owners to create and customize a web space over a network from a computer connected with the network, the computer readable medium comprising:
computer program code for creating a space with a service provider of the application;
computer program code for customizing the space;
computer program code for defining one or more fee based subscription plans for subscribers; and
computer program code for defining a level of access that a subscriber will have with respect to the space wherein the level of access depends on the privileges afforded by the one or more fee based subscription plans.

18. The computer readable medium of claim 17 wherein the network is the Internet.

19. The computer readable medium of claim 17 wherein the computer program code for creating a space comprises:
computer program code for collecting data pertaining to an account owner;
computer program code for establishing a fee structure between the account owner and the service provider of the application for usage of the application; and,
computer program code for establishing an log-in identifier for the account owner to access the space.

20. The computer readable medium of claim 17 wherein level of access includes reader access in which a subscriber is permitted to view content in the space.

21. The computer readable medium of claim 17 wherein the level of access includes commenter access in which a subscriber can view the content in the space and provide comments on the content in the space.

22. The computer readable medium of claim 17 wherein the level of access includes author access in which a subscriber can view the content in the space, provide comments on the content in the space, and create new content in the space.

23. The computer readable medium of claim 17 wherein computer program code for defining one or more fee based subscription plans comprises:
computer program code for creating one or more offer codes wherein an offer code includes terms pertaining to a length of a subscription, a fee for the length of the subscription, and a level of access to the space to be afforded by the subscription.

24. The computer readable medium of claim 23 wherein an offer code can be distributed via email.

25. The computer readable medium of claim 23 wherein an offer code includes an expiration date such that the terms included with the offer code are invalid upon reaching the expiration date.

26. The computer readable medium of claim 23 wherein the level of access to the space to be afforded by the subscription includes: reader access in which a subscriber is permitted to view content in the space; commenter access in which a subscriber can view the content in the space and provide comments on the content in the space; and author access in which a subscriber can view the content in the space, provide comments on the content in the space, and create new content in the space.

27. The computer readable medium of claim 23 wherein the length of a subscription includes: a renewable monthly term; a renewable yearly term; and a permanent term.

28. The computer readable medium of claim 17 further comprising computer program code for tracking usage statistics of the space.

29. The computer readable medium of claim 28 wherein usage statistics include at least one of page hit counts, offer code table, subscription accounting summary, subscriber information, list of readers, list of commenters, list of authors, list of accessed content, monies collected, memory used, and recent subscriber activity.

30. The computer readable medium of claim 17 wherein the computer program code for customizing the space further comprises computer program code for adding content to the space.

31. The computer readable medium of claim 30 wherein the computer program code for adding content to the space is based on wiki formatting.

32. The computer readable medium of claim 31 wherein content includes at least one of blog entries, task entries, forum entries, image files, audio files, video files, data files, and calendar entries.
